(19) United States
(12) Patent Application Publication
(10) Pub. No.: US 2022/0286534 A1
(43) Pub. Date: Sep. 8, 2022

(54) MERGING UNIT VERIFICATION USING UNIQUE IDENTIFIERS

(71) Applicant: Schweitzer Engineering Laboratories, Inc., Pullman, WA (US)

(72) Inventors: Bharat Nalla, Pullman, WA (US); Vishal Patil, Alpharetta, GA (US); Lisa Gayle Nelms, Colfax, WA (US); Lihua Ran, Pullman, WA (US); Ozan Akyildiz, Pullman, WA (US)

(73) Assignee: Schweitzer Engineering Laboratories, Inc., Pullman, WA (US)

(21) Appl. No.: 17/190,801

(22) Filed: Mar. 3, 2021

(51) Int. Cl. H04L 29/06; H04L 29/08; G05B 19/042; H02H 1/00; H02H 7/20

(52) U.S. Cl. CPC H04L 69/22; H04L 69/18; H04L 67/12; G05B 19/0428; H02H 1/0092; H02H 1/0007; H02H 7/20; H04L 2212/00; G05B 2219/25257; G05B 2219/25252; G05B 2219/21154; G05B 2219/21155

(57) ABSTRACT

The present disclosure pertains to systems and methods to verify information received from a merging unit. In one embodiment, a system may include a merging unit interface comprising a port configured to communicate with the merging unit. The system may include a commissioning subsystem to receive a unique identifier (“UID”) associated with the merging unit using the port during a commissioning process, to store the UID associated with the merging unit, and to associate the UID with the port. In operation, a verification subsystem may receive a plurality of transmissions from the merging unit and verify that the plurality of transmissions originated from the merging unit based on matching the UID stored in the commissioning process with the UID in the plurality of transmissions, and confirming that the plurality of transmissions is received through the port associated with the UID.

### TECHNICAL FIELD

The present disclosure pertains to verification of equipment communication in an electric power system. More particularly, but not exclusively, the systems and methods disclosed herein may be used to verify connections and communication between a merging unit and a protective relay or other type of intelligent electronic device (IED) in an electric power system.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a block diagram of a portion of an electric power system consistent with embodiments of the present disclosure.

FIG. 2 illustrates a commissioning process using software, an IED, and a merging unit consistent with embodiments of the present disclosure.

FIG. 3 illustrates a functional block diagram of a system comprising a merging unit and an IED, in which the IED verifies measurements and/or information received from a merging unit using a UID and consistent with embodiments of the present disclosure.

FIG. 4 illustrates a flow chart of a method for commissioning a system comprising a merging unit and an IED and verifying measurements and/or information received by the IED from the merging unit using a UID and consistent with embodiments of the present disclosure.

### DETAILED DESCRIPTION

Modern electric power systems are complex and utilize equally complex communication systems to monitor, automate, and protect the electric power systems. Configuring and maintaining such systems is a difficult task. The difficulty may manifest itself in inadvertent misconnection of devices, during commissioning of systems, or when new equipment is added. Incorrect routing of information in an electric power system may disrupt the electric power system and result in power outages.

The inventors of the present disclosure have recognized that certain advantages may be realized by utilizing unique identifiers (“UID”) associated with equipment in electric power systems to monitor communication links. Communication links between devices may be established during commissioning, and the devices may subsequently verify the communication links during the operation of the electric power system using the unique identifiers. In this way, if a piece of equipment is inadvertently disconnected from one device and re-connected to another, the change may be identified and a user may be notified. Further, systems consistent with the present embodiment may suppress actions based on values from the incorrectly connected device.

Some embodiments consistent with the present disclosure may be implemented in connection with merging units. A merging unit measures an analog electrical parameter, digitizes the measurement, and transmits the measurement in a digital format. Merging units consistent with the present disclosure may include a UID in the digital messages that may be verified by a receiving device. If a device, such as an intelligent electronic device (“IED”) receives a message with an unexpected UID, the message may be selectively discarded and an alert may be generated to alert an operator of the issue.

As used herein, an IED may refer to any microprocessor-based device that monitors, controls, automates, and/or protects monitored equipment within a system. Such devices may include, for example, differential relays, distance relays, directional relays, feeder relays, overcurrent relays, voltage regulator controls, voltage relays, breaker failure relays, generator relays, motor relays, remote terminal units, automation controllers, bay controllers, meters, recloser controls, communication processors, computing platforms, programmable logic controllers (PLCs), programmable automation controllers, input and output modules, and the like. The term IED may be used to describe an individual IED or a system comprising multiple IEDs. Further, IEDs may include sensors (e.g., voltage transformers, current transformers, contact sensors, status sensors, light sensors, tension sensors, etc.) that provide information about the electric power system.

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need to be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Several aspects of the embodiments disclosed herein may be implemented as software modules or components. As used herein, a software module or component may include any type of computer instruction or computer-executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. A module or component may comprise a single instruction or many instructions and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable media suitable for storing electronic instructions. In some embodiments, the computer or another electronic device may include a processing device such as a microprocessor, microcontroller, logic circuitry, or the like. The processing device may further include one or more special-purpose processing devices such as an application-specific interface circuit (ASIC), PAL, PLA, PLD, field-programmable gate array (FPGA), or any other customizable or programmable device.

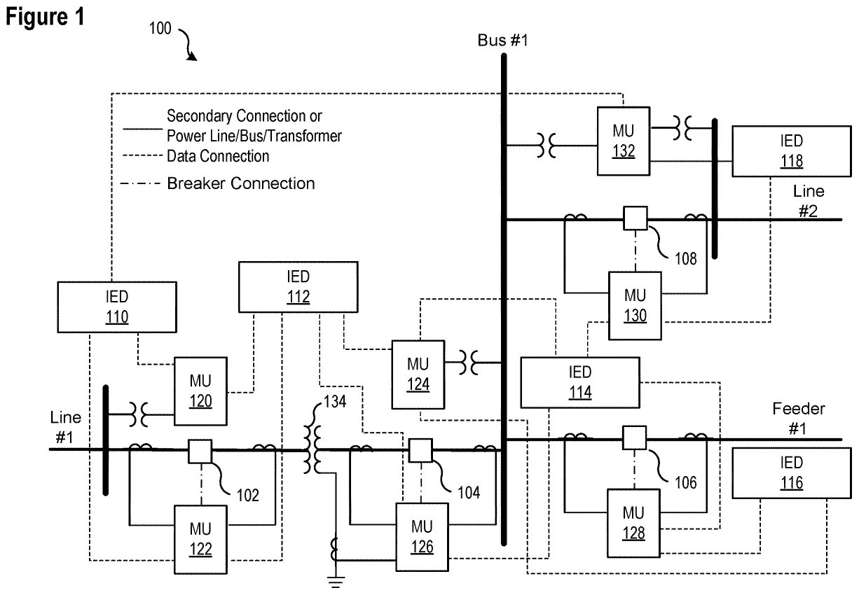

FIG. 1 illustrates a block diagram of a portion of an electric power system 100 consistent with embodiments of the present disclosure. Electric power system 100 may represent equipment commonly found in a substation of an electric power system. Power may be supplied by Line #1 and Line #2. Bus #1 connects Line #1 and Line #2 and Feeder #1, which may provide power to electrical loads. A transformer 134 may change the voltage between Line #1 and Bus #1. For example, Line #1 may connect to a high-voltage transmission line, and transformer 134 may step down the voltage to a level suitable for distribution. A plurality of breakers 102, 104, 106, and 108 may selectively interrupt electrical current. Breaker 102 may disconnect electric power system 100 from Line #1. Breakers 102 and 104 may electrically isolate transformer 134. Breaker 108 may disconnect electric power system 100 from Line #2. Breaker 106 may disconnect Feeder #1, thereby cutting off power to loads served by Feeder #1.

Electric power system 100 includes several IEDs 110, 112, 114, 116, and 118 that monitor, automate, and protect electric power system 100. Various IEDs may receive analog and binary inputs from a digital secondary system (DSS). DSS technology uses remote data acquisition devices to measure currents and voltages and perform substation control operations. This technology provides flexible solutions, reduces the cost of installing cabling, and improves overall safety in the substation. DSS technology may use various communication protocols, such as the Time-Domain Link (“TiDL”) Protocol (“T-Protocol”), the Sampled Values (“SV”) Protocol encapsulated in the T-Protocol, etc.

A plurality of merging units 120, 122, 124, 126, 128, and 130 may sample voltages and/or currents at various locations in electric power system 100 and transmit streams of digitized values to the IEDs 110, 112, 114, 116, and 118. In various embodiments, merging units 120, 122, 124, 126, 128, 130, and 132 may communicate with the plurality of IEDs 110, 112, 114, 116, and 118 using T-Protocol. T-Protocol is non-routable, which precludes interactive remote user access to minimize security complexity and the associated costs.

IEDs 110, 112, 114, 116, and 118 may be configured to perform specific tasks based on the equipment to which each IED is connected. For example, IED 112 may be embodied as a transformer protection relay, such as the SEL-487E-5 Transformer Protection Relay available from Schweitzer Engineering Laboratories (“SEL”) of Pullman, Wash. IED 112 may receive voltage measurements from merging units 120 and 124 and may receive current measurements from merging units 122 and 126. These current and voltage measurements may allow IED 112 to monitor and protect transformer 134 from a variety of conditions that could cause damage. Similarly, IED 114 may be embodied as a the SEL-487B bus differential and breaker failure relay from SEL. IED 114 may receive voltage and current measurements from each of merging units 124, 126, 128, and 130.

Each merging unit in electric power system 100 is connected to multiple IEDs, and the IEDs use the measurements made by the merging units to monitor and protect the electric power system equipment in electric power system 100. Correct operation of electric power system 100 relies on communication among various elements, and undesired operation may occur if communication is disrupted or rerouted. For example, if the connections between merging units 120 and 124 are switched, IED 112 may implement a protective action (e.g., actuating breakers 102 and 104) to electrically isolate transformer 134.

To prevent miscommunication and undesired operation, each merging unit in electric power system 100 may include a UID in its transmissions, and each IED may verify the UID before acting upon information. In various embodiments, the UID may comprise a serial number, a hardware identifier, a randomly assigned value, etc. In various embodiments, the UID may be transmitted in each message, transmitted on a fixed schedule, or transmitted on a variable schedule. In one specific embodiment, a merging unit transmits its UID every 100 microseconds, and the receiving IED verifies the UID every 100 microseconds. Such a rapid transmission allows a connected relay to verify continuous communication and detect a disconnection of the communication medium. Expiration of the period or delay in receipt of the UID may provide an indication that communication has been interrupted.

Various techniques may be used to pair merging units and IEDs using a UID. In one embodiment, electric power system 100 may operate in a commissioning configuration in which the plurality of merging units 120, 122, 124, 126, 128, 130, and 132 provide a stream of measurements including the UIDs. The receiving IEDs may identify and store the UID associated with each communication port. Once the UID is stored for a particular communication port, the IED may verify subsequent communication using the stored UID. In some embodiments, measurements that lack the UID or that include a different UID may be selectively discarded.

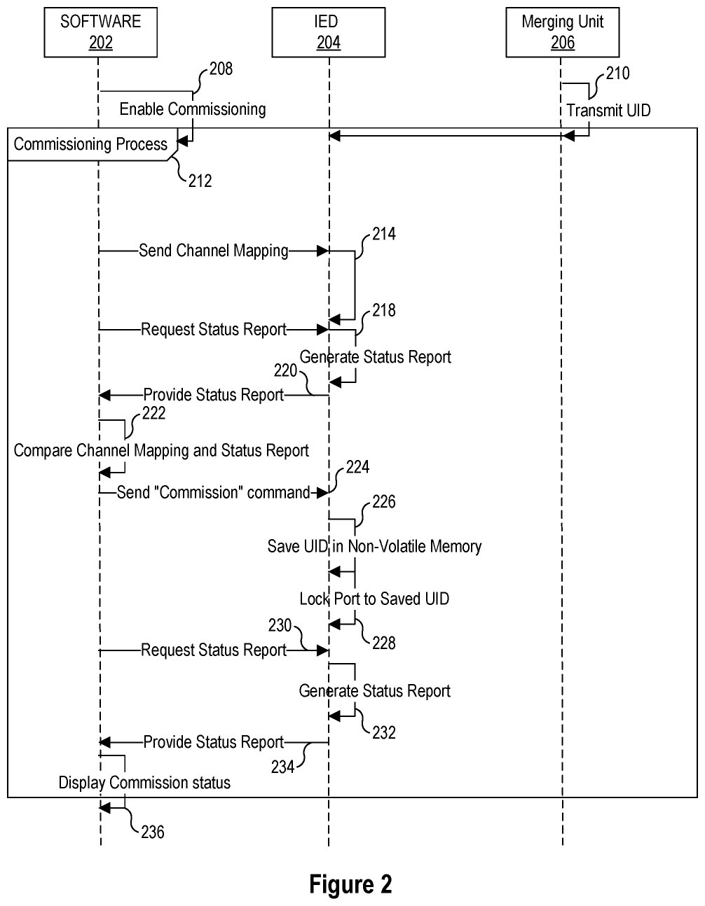

FIG. 2 illustrates a commissioning process using software 202, an IED 204, and a merging unit 206 consistent with embodiments of the present disclosure. Commissioning process 212 may be used in one specific embodiment to set up communications in electric power system 100 illustrated in FIG. 1. Software 202 may enable commissioning 208 to initiate a commissioning process 212. Merging unit 206 may transmit its UID 210 to IED 204.

Software 202 may provide a channel mapping 214 to IED 204. The channel mapping 214 may identify the types of information IED 204 will receive from merging unit 206 and other connected devices. Software 202 may also request a status report 218 that is provided at 220. The status report 218 may provide confirmation that IED 204 has implemented the channel mapping 214. The channel mapping 214 and status report 218 may be compared 222 to ensure that IED 204 successfully implemented the channel mapping 214. If necessary, the channel mapping 214 may be resent by software 202 to IED 204 to correct any issues.

A commission command 224 may be sent to instruct the IED to associate the transmitted UID 210 with a particular communication port. The UID may be saved to a non-volatile memory 226, and the port may be locked to the saved UID 228. In some embodiments, locking the port may ensure that only communications including the saved UID are deemed valid and used by IED 202 for protection functions. Communications that do not include the saved UID may be discarded and/or actions based on such communications may be suppressed.

A request for a status report 230 may be sent by software 202 to IED 204, and the IED 204 may generate the status report 232 and provide it 234 to software 202. This exchange may provide confirmation that the UID has been saved and locked to the port. The software may display the commission status 236 before the commissioning process 212 ends.

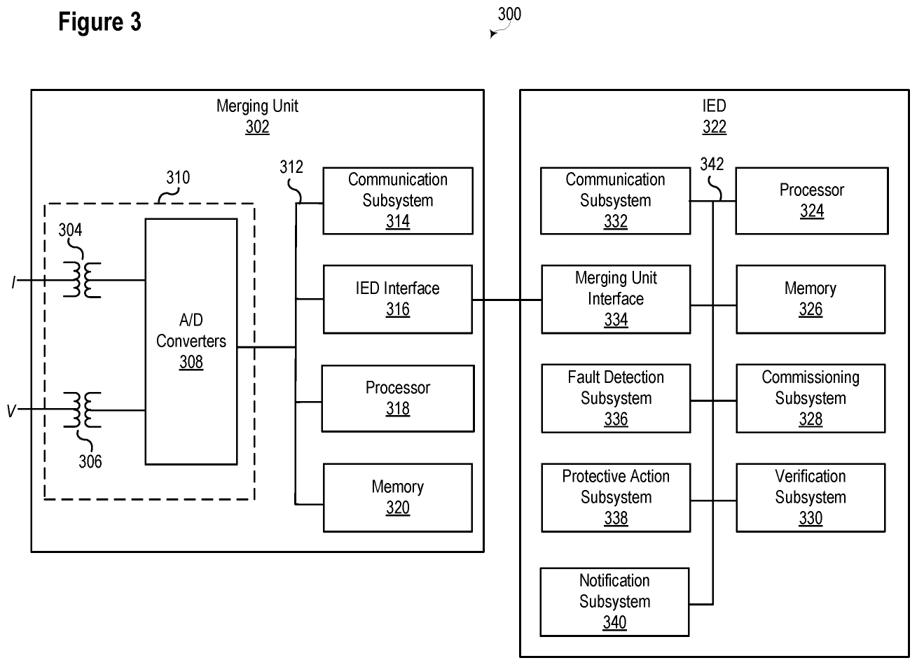

FIG. 3 illustrates a functional block diagram of a system 300 comprising a merging unit 302 and an IED 322, in which the IED 322 verifies measurements and/or information received from merging unit 302 using a UID and consistent with embodiments of the present disclosure. In one embodiment, merging unit 302 may be embodied as one of the merging units illustrated in FIG. 1, and IED 304 may be embodied as one of the IEDs illustrated in FIG. 1. System 300 may be implemented using hardware, software, firmware, and/or any combination thereof.

Processor 318 processes communications received via communication subsystem 314, IED interface 316, and the other subsystems and components in merging unit 302. Processor 318 may operate using any number of processing rates and architectures. Processor 318 may perform various algorithms and calculations described herein. Processor 318 may be embodied as a general-purpose integrated circuit, an application-specific integrated circuit, a field-programmable gate array, and/or any other suitable programmable logic device. Processor 318 may communicate with other elements in merging unit 302 by way of data bus 312.

Memory 320 may comprise any of a variety of transitory and non-transitory computer-readable storage media. Memory 320 may comprise executable instructions to perform processes described herein. Memory 320 may comprise machine-readable media such as, but is not limited to, hard drives, removable media, optical disks, CD-ROMs, DVD-ROMs, ROMs, RAMs, EPROMs, EEPROMs, magnetic or optical cards, solid-state memory devices, or other types of media/machine-readable media suitable for storing electronic instructions. Such electronic instructions may be executed on processor 318.

Merging unit 302 may acquire analog voltage and current measurements, digitize the measurements, and transmit the measurements in a digital format to IED 322. A sensor subsystem 310 may receive current measurements (l) and/or voltage measurements (V). The sensor subsystem 310 may comprise analog-to-digital (“A/D”) converters 308 that sample and/or digitize filtered waveforms to form corresponding digitized current and voltage signals provided to a data bus 312. A current transformer 304 and/or a voltage transformer 306 may include separate signals from each phase of a three-phase electric power system.

Communication subsystem 314 may format communications according to a variety of communication protocols and standards. In one embodiment, communication subsystem 314 may provide a stream of measurements obtained by sensor subsystem 310 in the T-Protocol.

IED interface 316 may allow communication between merging unit 302 and IED 322. IED interface 316 may be in communication with merging unit interface 334. IED interface 316 and merging unit interface 334 may allow for bi-directional communication. For example, merging unit 302 may communicate a stream of measured values, and IED 322 may communicate protective actions (e.g., actuating a breaker) to be implemented by merging unit 302. Merging unit interface 334 may comprise a plurality of ports configured to communicate with a plurality of merging units although only a single merging unit 302 is shown in FIG. 3.

Processor 324 processes communications received via communication subsystem 332, merging unit interface 334, and the other subsystems and components in IED 322. Processor 324 may operate using any number of processing rates and architectures. Processor 324 may perform various algorithms and calculations described herein. Processor 324 may be embodied as a general-purpose integrated circuit, an application-specific integrated circuit, a field-programmable gate array, and/or any other suitable programmable logic device. Processor 324 may communicate with other elements in IED 322 by way of bus 342.

Memory 326 may comprise any of a variety of transitory and non-transitory computer-readable storage media. Memory 326 may comprise executable instructions to perform processes described herein. Memory 326 may comprise machine-readable media such as, but is not limited to, hard drives, removable media, optical disks, CD-ROMs, DVD-ROMs, ROMs, RAMs, EPROMs, EEPROMs, magnetic or optical cards, solid-state memory devices, or other types of media/machine-readable media suitable for storing electronic instructions. Such electronic instructions may be executed on processor 324.

A commissioning subsystem 328 may allow IED 322 to be configured for communication with specific IEDs based on a UID of a merging unit. In one specific embodiment, commissioning subsystem 328 may implement the commissioning process illustrated in FIG. 2.

A verification subsystem 330 may verify communications originated from merging unit 302 based on a UID. Verification subsystem 330 may be configured to selectively discard measurements or information received from merging unit 302 if such measurements or information are associated with an unexpected UID. In other embodiments, verification subsystem 330 may operate in conjunction with protective action subsystem 338 to restrain protective actions based on such measurements or information.

Communication subsystem 332 may format communications according to a variety of communication protocols and standards. In one embodiment, communication subsystem 332 may be configured to receive a stream of measurements from merging unit 302 in the T-Protocol. Communication subsystem 332 may also provide the ability for IED 322 to communicate with other devices via a variety of communication media and communication protocols.

A fault detection subsystem 336 may be configured to analyze measurements or information received from merging unit 302 to identify a fault or other type of anomalous conditions. Faults may comprise a variety of types of conditions, such as an over-current condition, an over-voltage or under-voltage condition, an over-frequency or under-frequency condition, etc.

Protective action subsystem 338 may implement a protective action based on the identification of a fault by fault detection subsystem 336. In various embodiments, a protective action may include tripping a breaker, selectively isolating or disconnecting a portion of the electric power system, etc. Protective action subsystem 338 may coordinate protective actions with other devices in communication with IED 322.

A notification subsystem 340 may generate a notification alerting a user when any of the communications from merging unit 302 are not verified. In various embodiments, the notification may comprise an alert sent to an operator of system 300. The alert may take a variety of forms, such as a notification sent to a supervisory system (e.g., a supervisory control and data acquisition (“SCADA”) system, a wide-area situational awareness (“WASA”) system, etc.) of an electric power system, an email message, a text message, etc.

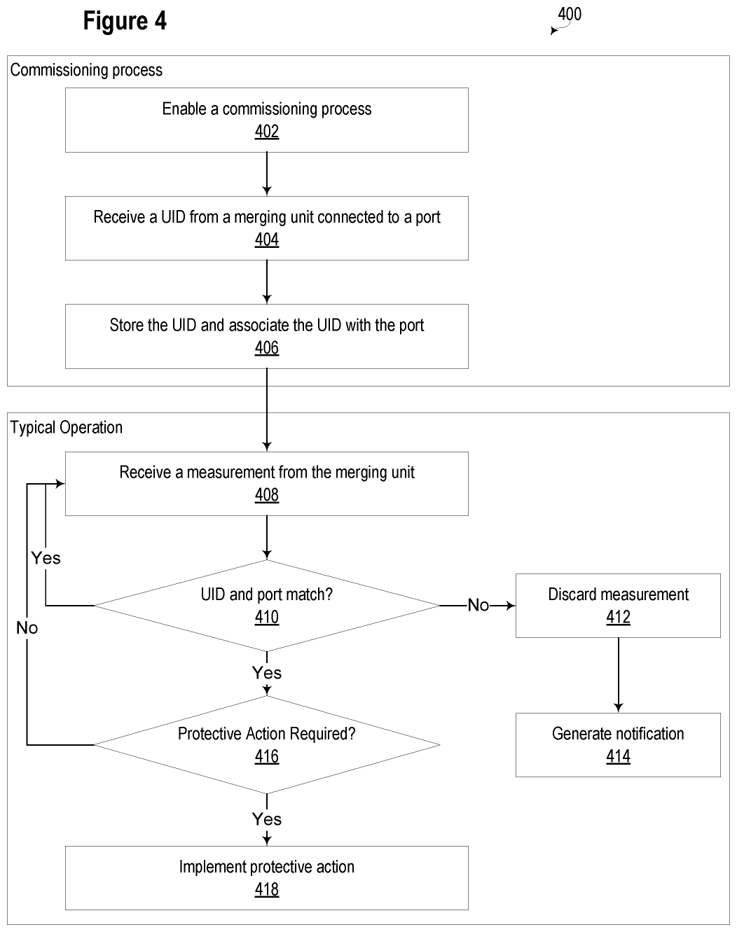

FIG. 4 illustrates a flow chart of a method 400 for commissioning a system comprising a merging unit and an IED and verifying measurements and/or information received by the IED from the merging unit using a UID and consistent with embodiments of the present disclosure. At 402, a commissioning process may be enabled. In one specific embodiment, the commissioning process may follow the steps illustrated in FIG. 2.

At 404, an IED or other device may receive a UID from a merging unit using a particular port. The UID may comprise a serial number, a hardware identifier, a randomly assigned value, etc. In some embodiments, the UID may be unrelated to routing of communications between the merging unit and an IED. In other words, the UID may comprise an identifier in addition to information used in typical network communications (e.g., a media access control address, an Internet protocol address, etc.).

At 406, the UID may be stored and the UID may be associated with the port. IEDs may be in communication with a plurality of merging units, and each port may be locked or associated with a particular merging unit's UID. By associating a UID with a particular port, a system consistent with the present disclosure may be able to determine when a merging unit previously in communication with a first port is subsequently connected to a second port based on the merging unit's UID.

At 408, system 400 may transition to a typical mode of operation in which a stream of transmissions from the merging unit is sent to the IED. The transmissions may include information about an electric power system (e.g., current measurements, voltage measurements, equipment status, etc.). In some embodiments, each message in the stream of transmissions may include the UID, thus allowing the IED to verify that each message originated from a particular merging unit using the UID. In other embodiments, the UID may be transmitted according to a schedule. A delay in receipt of the UID, either based on a schedule or based on a lack of transmissions comprising the UID, may indicate that communication with the merging unit has been interrupted.

In one embodiment, data measurements may be encoded in a data packet according to a first communication protocol (e.g., IEC 61850-9-2 Sampled Values protocol), and the first data packet may be encapsulated within a second packet encoded according to a second communication protocol (e.g., T-Protocol). The encapsulation of the first data packet within the second data packet may allow systems and methods consistent with the present disclosure to utilize communication protocols that would not natively support the transmission of additional information that can be used for verification (e.g., the UID).

At 410, a system implementing method 400 may determine whether the UID and port match the UID and port stored in the commissioning process. If the UID and/or the port do not match the values stored in the commissioning process, the measurement may be discarded at 412. In other embodiments, the measurements may be retained, but other actions may be implemented to prevent undesired operations. For example, protective actions may be restrained that would otherwise be triggered by such measurements.

At 414, a notification may be generated to alert a user of the failed verification. The alert may take a variety of forms, such as a notification sent to a supervisory system (e.g., a SCADA system, a WASA system, etc.) of an electric power system, an email message, a text message, etc.

If the UID and port match the UID and port stored in the commissioning process, method 400 may determine at 416 if protective action is required. Protective actions may be implemented when the measurement is indicative of a fault or other type of anomalous conditions. Protective actions may include actuating breakers to disconnect portions of an electrical system, increasing generation capacity, providing reactive power support, adjusting voltages, etc. If a protective action is required, the protective action may be implemented at 418.

While specific embodiments and applications of the disclosure have been illustrated and described, it is to be understood that the disclosure is not limited to the precise configurations and components disclosed herein. Accordingly, many changes may be made to the details of the above-described embodiments without departing from the underlying principles of this disclosure. The scope of the present invention should, therefore, be determined only by the following claims.

What is claimed is:

1. A system to verify information received from a merging unit, the system comprising:
a merging unit interface comprising a port configured to communicate with the merging unit;
a commissioning subsystem to:
receive a unique identifier (“UID”) associated with the merging unit using the port during a commissioning process;
store the UID associated with the merging unit; and
associate the UID with the port;
a verification subsystem to:
receive a plurality of transmissions from the merging unit, each of the transmissions comprising information about an electric power system; and
verify that the plurality of transmissions originated from the merging unit based on:
matching the UID stored in the commissioning process with the UID in the plurality of transmissions; and
confirming that the plurality of transmissions is received through the port associated with the UID; and
a notification subsystem to generate a notification based on the verification subsystem failing to verify at least one of the plurality of transmissions.

2. The system of claim 1, wherein the UID comprises a serial number of the merging unit.

3. The system of claim 1, wherein each of the plurality of transmissions comprises the UID.

4. The system of claim 1, wherein the merging unit interface comprises a plurality of ports configured to communicate with a corresponding plurality of merging units, each of the plurality of merging units configured to generate a respective plurality of transmissions comprising a respective UID.

5. The system of claim 4, wherein the verification subsystem is further configured to determine that one of the plurality of merging units previously in communication with a first port is subsequently connected to a second port based on the UID.

6. The system of claim 1, wherein each of the plurality of transmissions comprises a first data packet encoded according to a first communication protocol and encapsulated within a second packet encoded according to a second communication protocol.

7. The system of claim 6, wherein the first communication protocol comprises an IEC 61850 protocol.

8. The system of claim 1, wherein the verification subsystem is configured to selectively discard any of the plurality of transmissions that are not verified.

9. The system of claim 1, further comprising a protective action subsystem to implement a protective action based on the plurality of transmissions verified by the verification subsystem;
wherein the verification subsystem is configured to restrain protective action based on any of the plurality of transmissions that are not verified.

10. The system of claim 1, wherein the notification subsystem is further configured to generate the notification based on expiration of a period following a delay in receipt of the UID.

11. A merging unit, comprising:
a sensor subsystem to generate an analog measurement of a parameter associated with an electric power system;
an analog-to-digital conversion subsystem to convert the analog measurement of the parameter to a digital measurement of the parameter;
a communication subsystem to:
generate a first packet comprising the digital measurement of the parameter and encoded according to a first communication protocol; and
encapsulate the first packet within a second packet comprising a unique identifier (“UID”) and encoded according to a second communication protocol; and
an intelligent electronic device (“IED”) interface to communicate the second packet to an IED.

12. The merging unit of claim 11, wherein the UID comprises a serial number of the merging unit.

13. The merging unit of claim 11, wherein the first communication protocol comprises an IEC 61850 protocol.

14. A method of verifying information received from a merging unit, the method comprising:
initiating a commissioning process;
receiving, during the commissioning process, a unique identifier (“UID”) associated with the merging unit using a port;
storing, during the commissioning process, the UID associated with the merging unit;
associating, during the commissioning process, the UID with the port;
receiving a plurality of transmissions from the merging unit, each of the transmissions comprising information about an electric power system;
verifying that the plurality of transmissions originated from the merging unit based on:
matching the UID stored in the commissioning process with the UID in the plurality of transmissions; and
confirming that the plurality of transmissions is received through the port associated with the UID; and
generating a notification based on failing to verify at least one of the plurality of transmissions.

15. The method of claim 14, wherein the UID comprises a serial number of the merging unit.

16. The method of claim 14, wherein each of the plurality of transmissions comprises the UID.

17. The method of claim 14, further comprising:
encoding the plurality of transmissions according to a first communication protocol; and
encapsulating the plurality of transmissions encoded according to the first communication protocol within a packet encoded according to a second communication protocol.

18. The method of claim 17, wherein the first communication protocol comprises an IEC 61850 protocol.

19. The method of claim 14, further comprising selectively discarding any of the plurality of transmissions that are not verified.

20. The method of claim 14, further comprising restraining a protective action based on any of the plurality of transmissions that are not verified.
